(19) United States
(12) Patent Application Publication
(10) Pub. No.: US 2008/0245205 A1
(43) Pub. Date: Oct. 9, 2008

(54) ENHANCED TABLE SAW SYSTEM AND METHOD

(76) Inventor: John L. Waddell, Redmond, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 12/098,204

(22) Filed: Apr. 4, 2008

Related U.S. Application Data
(60) Provisional application No. 60/921,976, filed on Apr. 4, 2007.

(51) Int. Cl. B26D 1/16

(52) U.S. Cl. 83/471.2

(57) ABSTRACT

An enhanced table saw system and method is discussed herein that addresses issues including set-up, control, and adjustment. The table saw includes a saw blade, a drive motor, a slideable cutting table, a positionable collection tray, a pivotable transmission assembly, and a stand assembly. The transmission assembly helps to couple the saw blade to the drive motor and allows for precise positioning of the saw blade with respect to the cutting table. An engagement assembly enables repositioning of the collection tray relative to the stand assembly to allow the table saw to accommodate to the work at hand.

### CROSS REFERENCE TO RELATED APPLICATION

This application claims priority benefit of provisional application Ser. No. 60/921,976 filed Apr. 4, 2007, the content of which is incorporated in its entirety.

### BACKGROUND OF THE INVENTION

1. Field of the Invention

The present invention is directed generally to saw systems.

2. Description of the Related Art

Conventional table saws are challenging to set up, control, and adjust.

### BRIEF DESCRIPTION OF THE SEVERAL VIEWS OF THE DRAWING(S)

FIG. 1 is a perspective view of an enhanced table saw in a first saw position, a first table position, and a first tray position.

FIG. 2 is a side elevational view of a first side of the enhanced table saw of FIG. 1 in the first saw position, the first table position and the first tray position with a cover of a transmission assembly removed.

FIG. 3 is a side elevational view of the first side of the enhanced table saw of FIG. 1 in a second saw position, the first table position and the first tray position.

FIG. 4 is a side elevational view of the first side of the enhanced table saw of FIG. 1 in a third saw position, the first table position and the first tray position.

FIG. 5 is a top plan view of a guide plate of the enhanced table saw of FIG. 1.

FIG. 6 is a side elevational view of the first side of the enhanced table saw of FIG. 1 in the second saw position, a second table position and the first tray position.

FIG. 7 is a side elevational view of the first side of the enhanced table saw of FIG. 1 in the second saw position, a third table position and the first tray position.

FIG. 8 is an elevational end view of a first end of the enhanced table saw of FIG. 1.

FIG. 9 is an enlarged fragmentary elevational end view of a portion of the first end toward the first side of the enhanced table saw of FIG. 1.

FIG. 10 is an enlarged fragmentary elevational end view of a portion of the first end toward a second side of the enhanced table saw of FIG. 1.

FIG. 11 is side sectional view of an engagement assembly included in the enhanced table saw of FIG. 1.

FIG. 12 is a side elevational view of the first side of the enhanced table saw of FIG. 1 in the second saw position, the first table position and a second tray position.

FIG. 13 is a side elevational view of the first side of the enhanced table saw of FIG. 1 in the second saw position, the first table position and a third tray position.

### DETAILED DESCRIPTION OF THE INVENTION

An enhanced table saw system and method is discussed herein that addresses issues including set-up, control, and adjustment. The table saw includes a saw blade, a drive motor, a slideable cutting table, a positionable collection tray, a pivotable transmission assembly, and a stand assembly. The transmission assembly helps to couple the saw blade to the drive motor and allows for precise positioning of the saw blade with respect to the cutting table. An engagement assembly enables repositioning of the collection tray relative to the stand assembly to allow the table saw to accommodate to the work at hand.

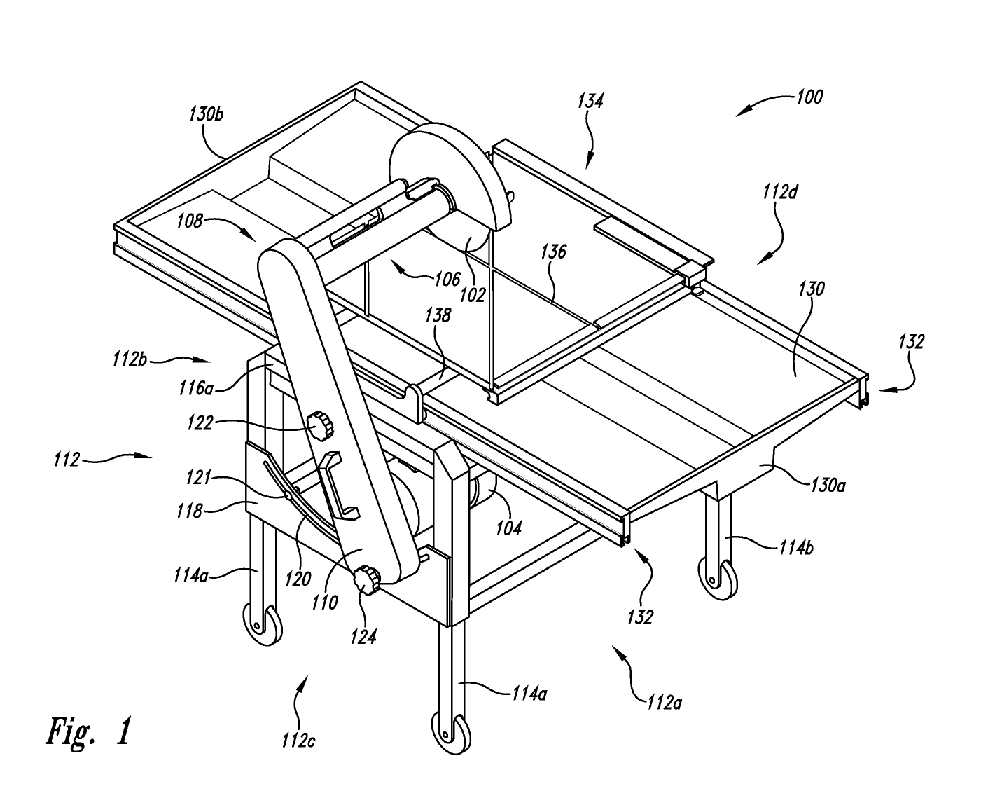

An enhanced table saw system 100 is shown in FIG. 1 to include a saw blade 102, a drive motor 104, a shaft assembly 106, and a transmission assembly 108 including a transmission housing 110. The shaft assembly 106 and the transmission assembly 108 combine to couple the saw blade 102 to the drive motor 104. The table saw 100 further includes a stand assembly 112 with a first end 112a, a second end 112b, a first side 112c, and a second side 112d. The first side 112c has a pair of legs 114a with a cross member 116a extending therebetween.

The second side 112d has a pair of legs 114b with a cross member 116b (not shown) extending therebetween. A guide plate 118 with an arched slot 120 and a stop 121 also extends between the pair of legs 114a. The transmission assembly 108 includes a coupler 122 and a coupler 124. The coupler 122 pivotally couples the transmission assembly 108 to the cross member 116a and the coupler 124 couples the transmission assembly 108 to the guide plate 118 through the arched slot 120.

The table saw 100 further includes a residue collection tray 130 having a first end 130a and a second end 130b, two rail assemblies 132, a cutting table 134 with a blade clearance groove 136, and support bracing 138. In some implementations, the rail assemblies 132 are affixed to either side of the tray 130 with each being detachably coupled to its respect one of the cross member 116a and the cross member 116b as discussed further below. The clearance groove 136 of the cutting table 134 allows the saw blade 102 to fully cut through a subject piece without damaging the cutting table 134. In implementations, the cutting table 134 is affixed to the support bracing 138, which in turn slideably engages with the rail assemblies 132.

The table saw 100 is depicted in FIG. 1 as having the saw blade 102 in a first position, the cutting table 1 34 in a first position, and the tray 130 in a first position. The first position of the saw blade 102 is such that the saw blade protrudes slightly into the clearance groove 136 of the cutting table 134 ready to cut without contacting the cutting table as not to cause damage to the cutting table. The first position of the cutting table 134 medially positions the cutting table relative to the stand assembly 112. The first position of the tray 130 medially positions the tray relative to the stand assembly 112.

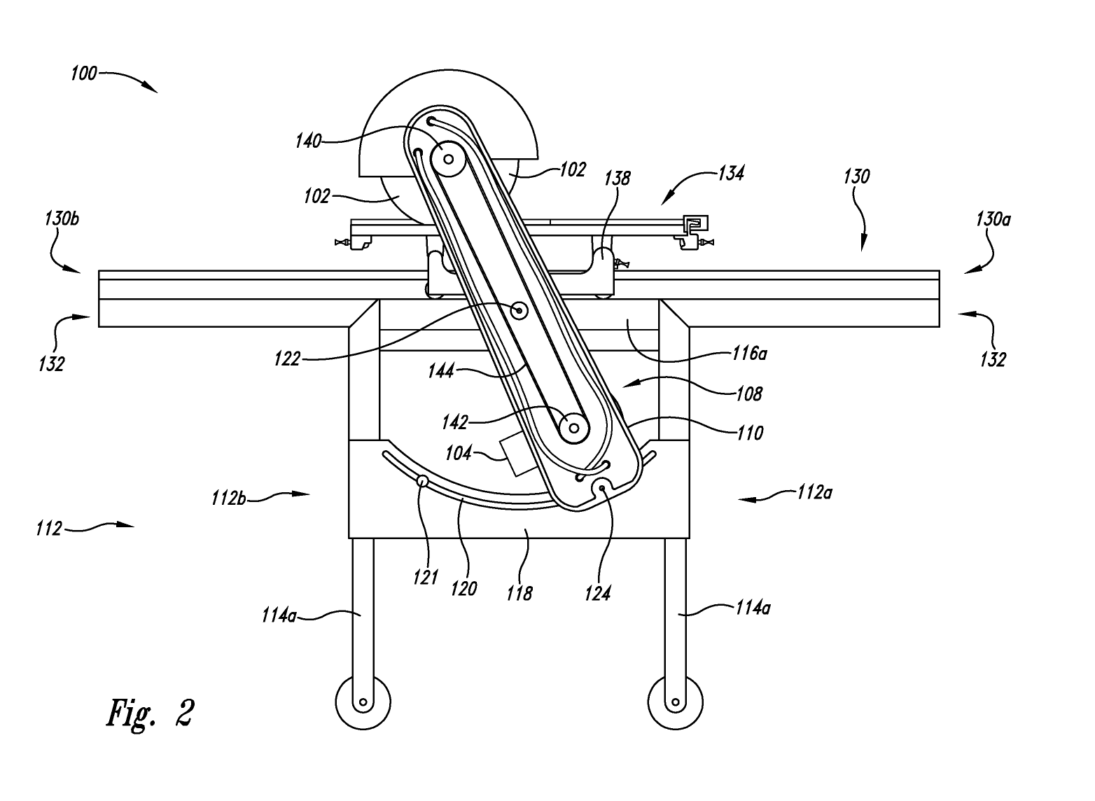

The transmission assembly 108 is shown in FIG. 2 with a portion of the housing 110 removed to reveal additional components including a pulley 140, a pulley 142, and a belt 144 coupled therebetween. The pulley 140 is coupled through the shaft assembly 106 to the saw blade 102. The pulley 142 is coupled to the drive motor 104.

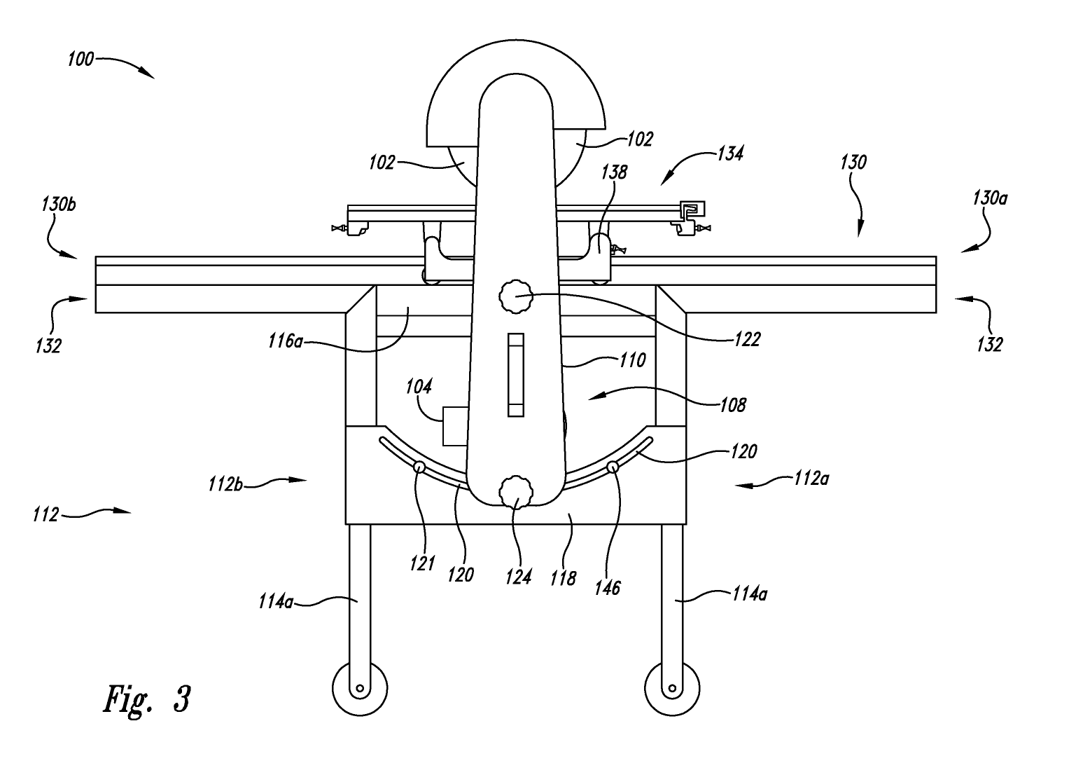

The pulley 140, the pulley 142, the shaft assembly 106, and the drive motor 104 are all coupled to the housing 110 of the transmission assembly 108 so that when the housing pivots about the coupler 122, the saw blade 102 can be lifted out of the clearance groove 136 as part of the first position of the saw blade shown in FIG. 2 and be fully raised above the cutting table 134 in a second position for the saw blade as shown in FIG. 3.

In implementations, to move the saw blade 102 from its first position to its second position, the coupler 122 and the coupler 124 unscrewed sufficiently to release the transmission assembly 108 from a fixed engagement with the cross member 116a and the guide plate 118. The transmission assembly 108 is then pivoted from a position associated with the first position of the saw blade as shown in FIG. 2 to a position associated with a second position of the saw blade shown in FIG. 3 whereupon the coupler 122 and the coupler 124 are screwed down tight to fixedly engage the transmission assembly with the cross member 116a and the guide plate 118. The second position of the saw blade 102 allows for both the stop 121 and a stop 146 to be visible.

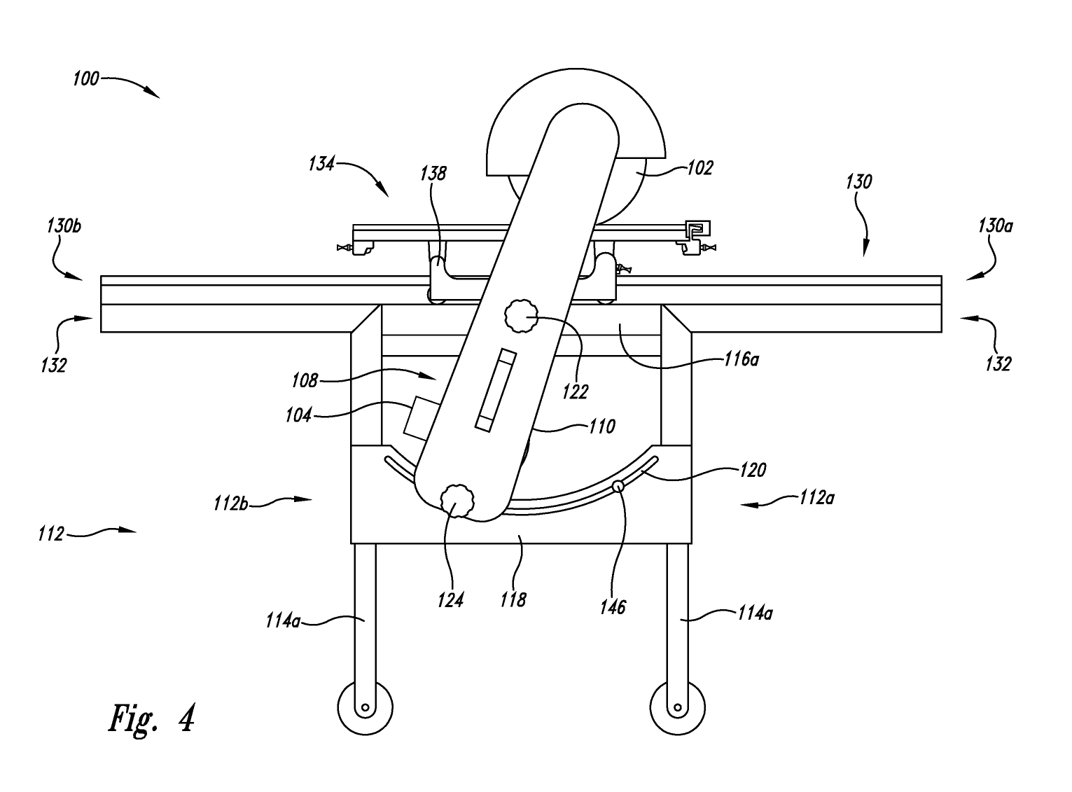

The first position of the saw blade 102 has the coupler 124 adjacent the stop 146. The saw blade 102 has a third position shown in FIG. 4 in which the coupler 124 is adjacent the stop 121. In its third position, the saw blade 102 protrudes slightly into the clearance groove 136 of the cutting table 134 ready to cut without contacting the cutting table. As shown in FIG. 5, the stop 121 and the stop 146 can each be fashioned from a nut and bolt pair. The coupler 124 can be fashioned from a bolt 124a and screw knob 124b.

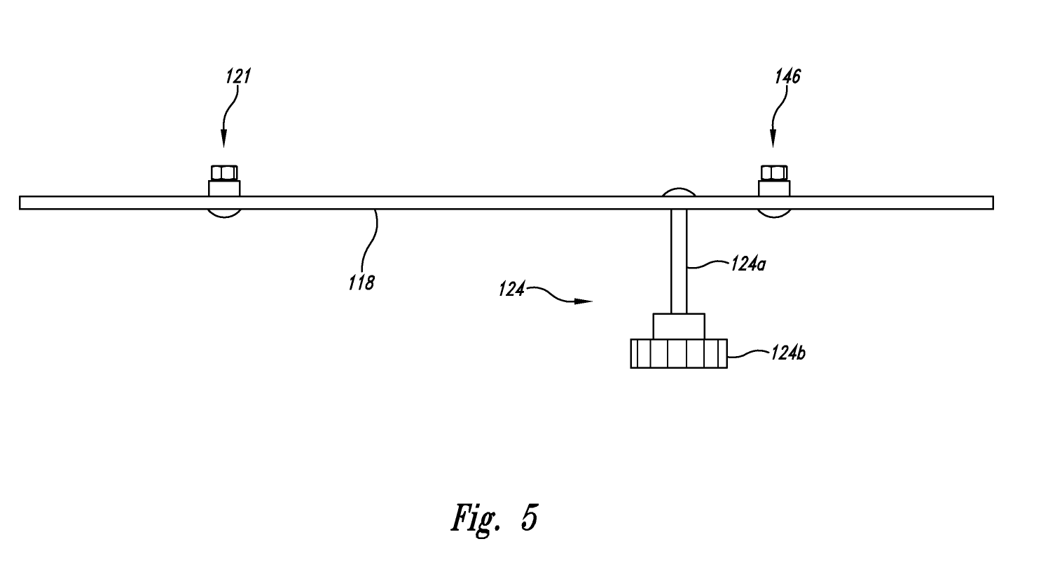

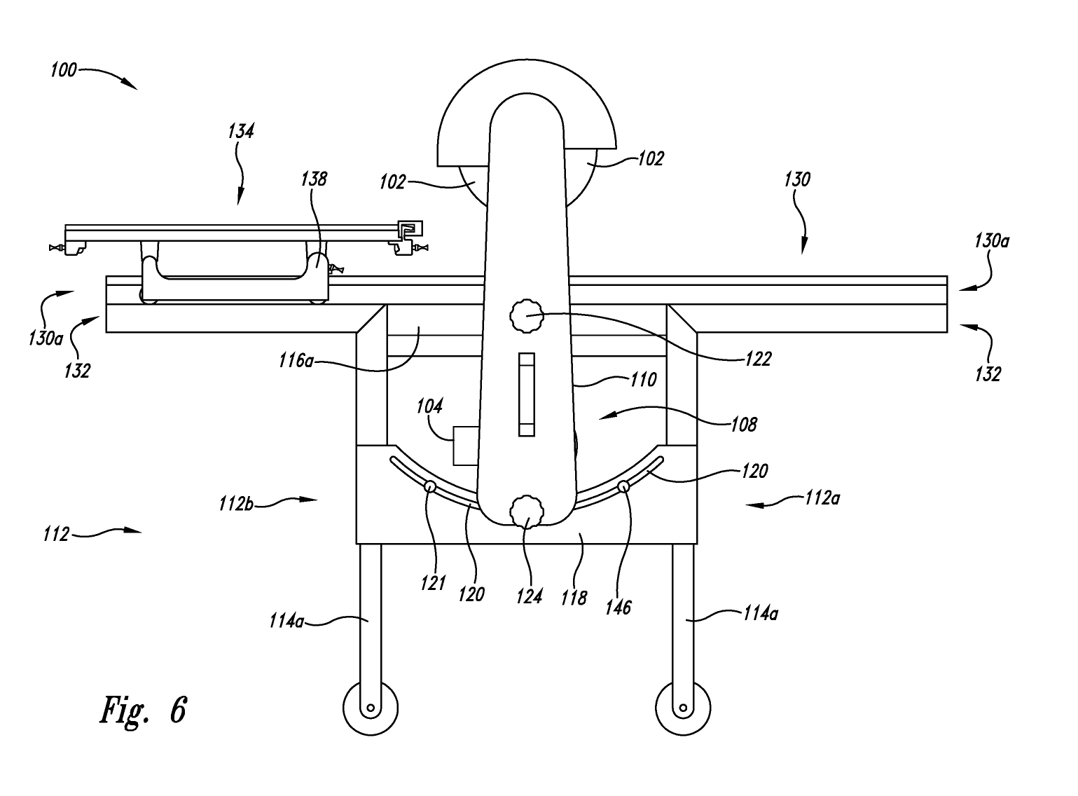

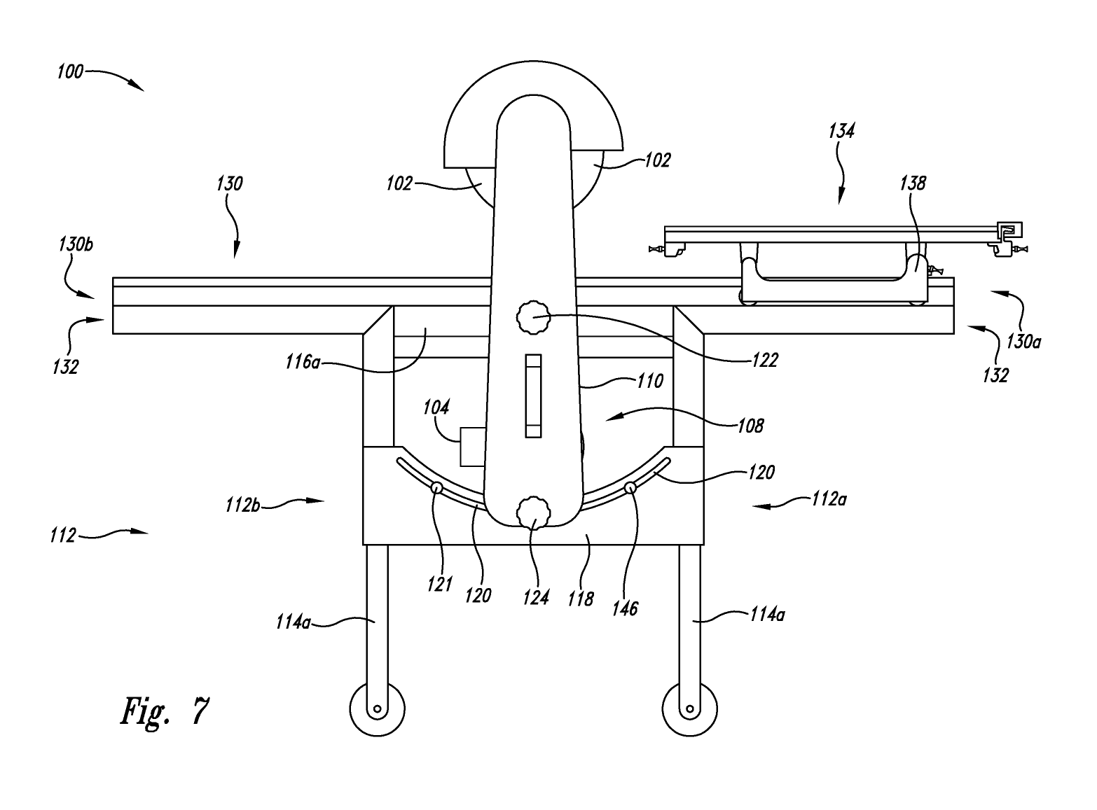

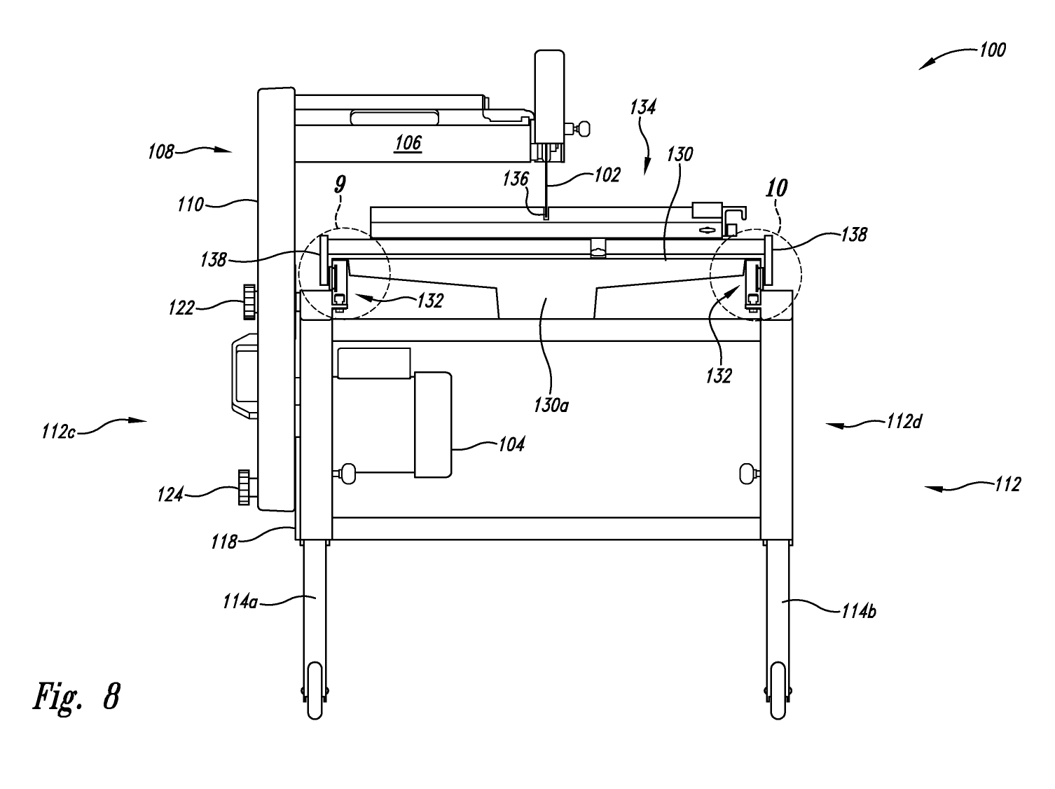

Due to the slideable engagement with the support bracing 138 with the rail assemblies 132, the cutting table can be slid from its first position to a second position toward the second end 130b of the tray 130 as shown in FIG. 6 and also slid to a third position toward the first end 130a of the tray as shown in FIG. 7.

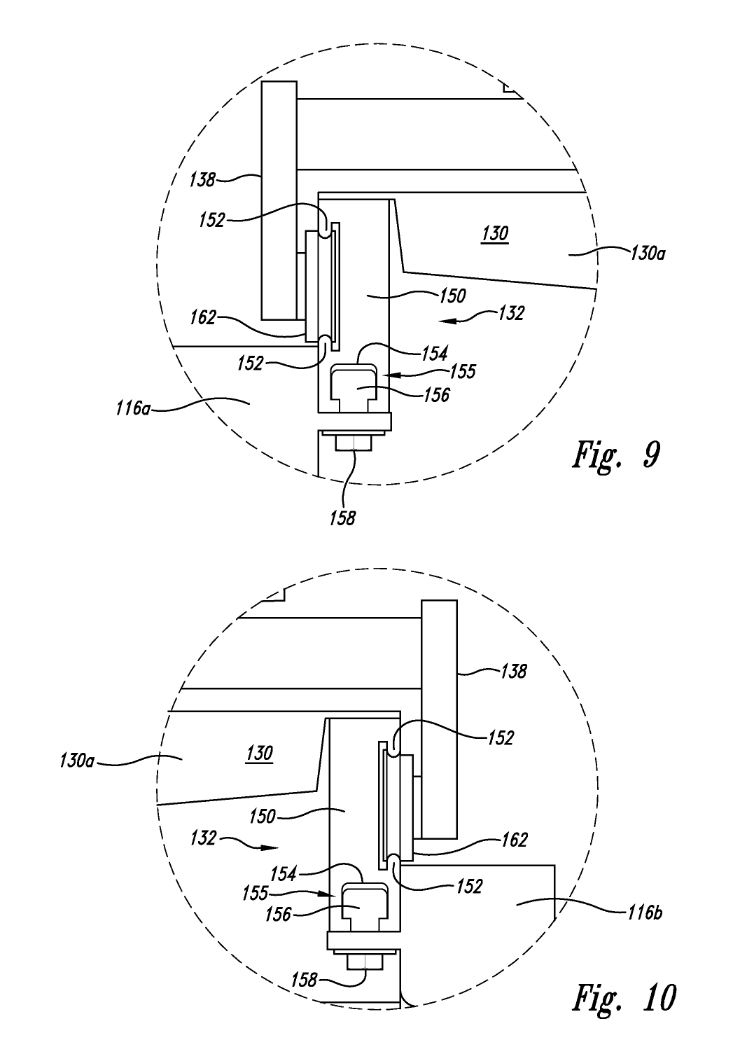

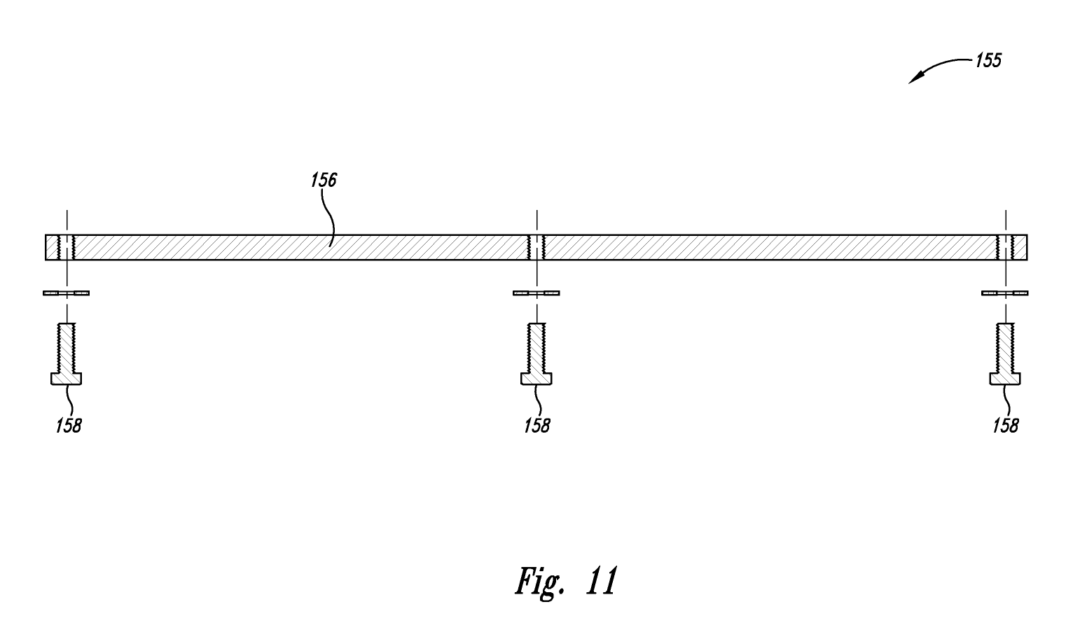

Detail showing engagement of the rail assemblies 132 with their respect one of the cross member 116a and the cross member 116b is shown in FIG. 8 and better shown in FIG. 9 and FIG. 10. The rail assembly 132 has a rail 150 that includes track portions 152 and a keyway 154. Further included is an engagement assembly 155 (further shown in FIG. 11) having an elongated bar 156 with a bolts 158 and washers. Referring to FIG. 9, to fixedly engage the rail assembly 132 and consequently also the tray 130 to the cross member 116a, the elongated bar 156 is positioned into the keyway 154.

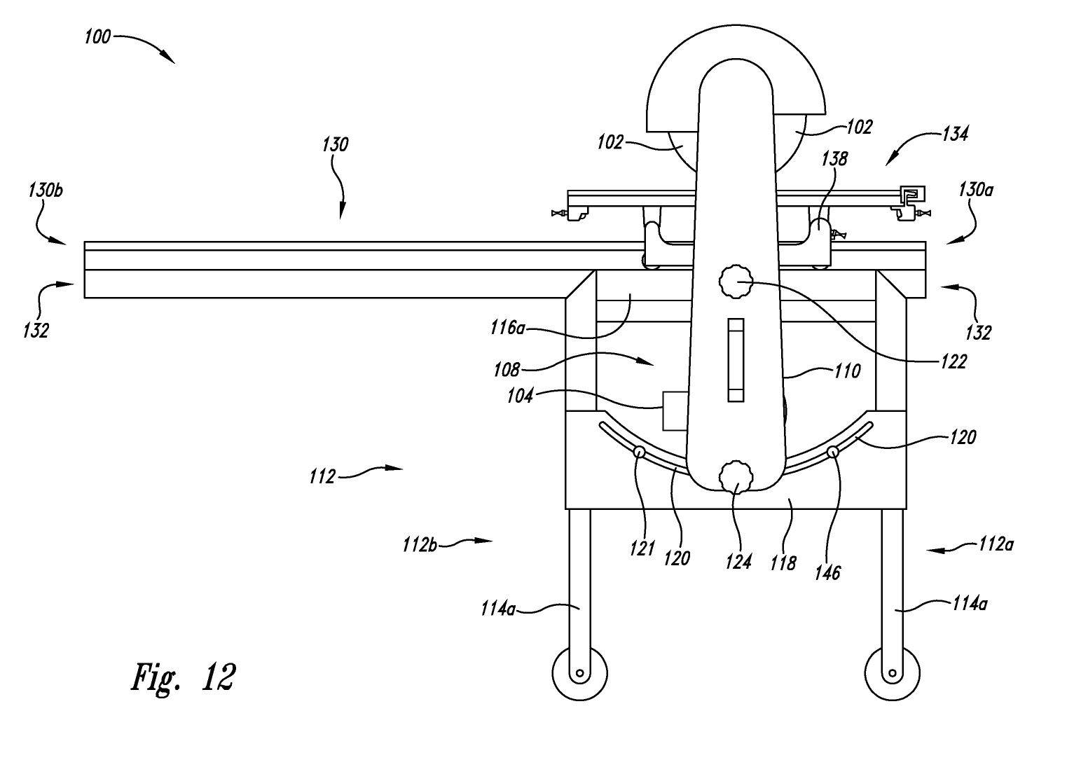

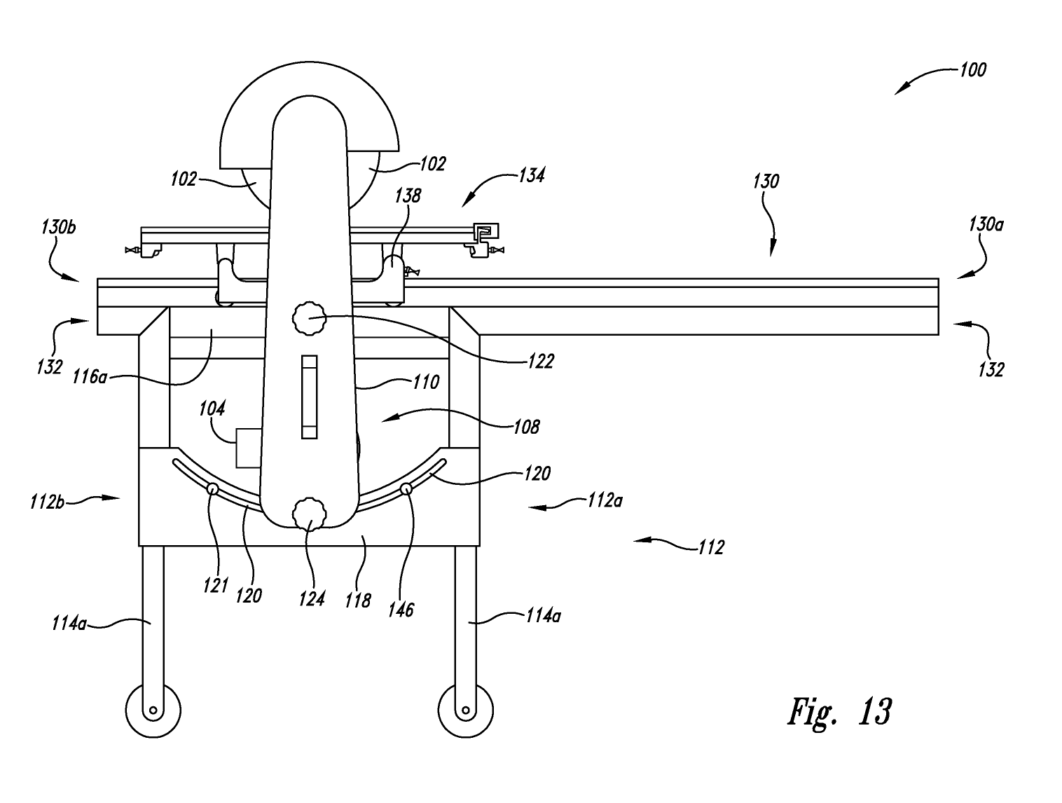

The bolts 158 are pushed through holes in a portion of the cross member 116a and threaded into the elongated bar 156. The tray 130 is then pushed into a desired position. The bolts 158 are then tightened to fixedly engage the rail assembly 132 and the tray 130 to the cross member 116a. A similar procedure is followed to engage the other rail assembly 132 with the cross member 116b. As shown, each side of the support bracing 138 has wheels 162, which ride in the track 152 of each of the rails 150 of the rail assemblies 132. As a consequence of the rail assemblies 132 being releaseably affixed to their respect one of the cross member 116a and the cross member 116b, the tray 130 can be moved to a second position shown in FIG. 12 and a third position shown in FIG. 13.

From the foregoing it will be appreciated that, although specific implementations have been described herein for purposes of illustration, various modifications may be made without deviating from the spirit and scope of the invention.

The invention claimed is:

1. A table saw comprising:
a stand assembly;
a saw blade;
a motor;
a shaft assembly coupled to the saw blade and
a transmission assembly coupled to the shaft assembly and the motor thereby coupling the saw blade to the motor, the transmission assembly pivotally coupled to the stand assembly, the saw blade being raised from a first position to a second position as the transmission assembly is pivoted from a first position to a second position.
